(19) United States
(12) Patent Application Publication
(10) Pub. No.: US 2014/0045647 A1
(43) Pub. Date: Feb. 13, 2014

(54) DRIVE FORCE DISTRIBUTING APPARATUS

(71) Applicant: Nissan Motor Co., Ltd., Yokohama-shi (JP)

(72) Inventor: Eigo Sakagami, Kawasaki-shi (JP)

(21) Appl. No.: 13/932,430

(22) Filed: Jul. 1, 2013

(30) Foreign Application Priority Data
Aug. 8, 2012 (JP) 2012-176255

(51) Int. Cl. F16H 13/10

(52) U.S. Cl. CPC F16H 13/10
USPC 476/8

(57) ABSTRACT

A drive force distributing device includes first and second rollers rotatable jointly with a main drive wheel system and a subordinate drive wheel system, respectively. A shaft portion of the second roller is rotatably supported via a bearing in an eccentric bore of a crankshaft that in turn is rotatable about a fixed axis of a housing. Control of the drive force distribution between the main drive wheels and the subordinate drive wheels is carried out by turning the second roller by the rotation of the crankshaft about the fixed axis to adjust the inter-roller pressing force by an adjustment mechanism which performs a reverse rotation control in which the turning direction of the second roller and the rotation direction of the second roller are in the opposite direction when the detected oil temperature exceeds a predetermined temperature. An identical rotation control is performed otherwise.

### CROSS-REFERENCE TO RELATED APPLICATION

This application claims priority under 35 U.S.C. §119 to Japanese Patent Application No. 2012-176255 filed Aug. 8, 2012, the entire disclosure of which is hereby incorporated herein by reference.

### FIELD OF THE INVENTION

The present invention generally relates to a vehicle drive force distributing apparatus. More particularly, the present invention relates to a drive force distributing apparatus suitable as a transfer for a four-wheel drive vehicle.

### BACKGROUND

In the Japanese Laid-open Patent Publication No. 2012-169171 (and corresponding U.S. Patent Application Publication No. 2011/0319223 A), an example of conventional transmission type drive force distributing apparatus is disclosed. The conventional drive force distributing apparatus shown is provided with a first roller mechanically coupled to a transmission system of main drive wheels and a second roller mechanically coupled to a drive system of subordinate drive wheels. The apparatus operates the first roller and the second roller to make contact with each other at their outer circumferential surfaces to distribute a part of a torque being transmitted to the main drive wheels to the subordinate drive wheels. Accordingly, a torque transmission capacity between the rollers can be controlled by adjusting a radial pressing force between the first roller and the second roller. The torque transmission capacity therefore controls the distribution of the drive force between the main drive wheel and the sub-drive wheel.

Such a mechanism for carrying out the drive force distributing control is proposed in the above referenced document, and, by arranging a shaft portion of the second roller within the crankshaft and driving the crankshaft by a motor and the like to thereby turn the axis portion of the second roller about a fixed axis of the housing. Thus, the second roller is radially displaceable relative to the first roller, and both the radial pressing force between the first and second rollers and the drive force distribution between the main and subordinate drive wheels are controlled. In this instance, by turning the shaft portion of the second roller in the direction opposite to the rotation direction of the second roller, the drive force distributing control will be carried out with high accuracy.

However, when the turning direction of the second roller is opposite to the rotational direction of the second roller, there is a possibility that responsiveness of control at low temperature may not be secured. Specifically, between members subjected to relative rotation such as the second roller or the crankshaft, a bearing is provided is immersed along with the second roller and crankshaft in lubricating oil. In this case, when the rotational direction of the second roller is revered from the rotational direction of crankshaft, the rotational direction of dragging torque exerted between the bearing and the crankshaft and the direction of torque driving the crankshaft to rotate will be opposite to each other. Therefore, when the dragging force increases at low oil temperature, the torque for driving the crankshaft to rotate will be decreased such that securing the control responsiveness has been difficult.

### BRIEF SUMMARY

The objective of the present invention is thus set in light of the above problem and resides in providing a drive force distributing apparatus enabling to achieve a stable assembly condition of the housing even when the first and second rollers are in contact with a slope or inclination angle to each other.

In one aspect of the drive force distributing apparatus according to the present invention, a drive force distributing apparatus is proposed in which an axis portion of the second roller is rotatably supported within an eccentric hollow bore and, by turning the second roller by the rotation of the crankshaft about the fixed shaft axis, to thereby adjust the pressing force of the second roller exerted against the first roller by an adjustment mechanism. Further, when an oil temperature is equal to or higher than a predetermined temperature, a drive force distribution is controlled by a reverse rotation control while, when the oil temperature is below the predetermined temperature, identical rotation control is in place for drive force distributing control in which the turning direction and the rotation direction of the second roller are in the same rotational direction.

The direction of turning of the second roller is controlled in reversed relation to the rotational direction of the second roller while the direction of the second roller may be adjusted to control drive force distribution between the main drive wheel and the sub-drive wheel, wherein the angle formed between the axis line of first roller and that of the second roller is a first angle, the angle between a first contact surface formed by the first roller and a first side wall and a second contact surface formed by the bearing support and housing is set larger than “zero”, and the angle between a contact surface formed by the second support and a second side wall and a contact surface between the bearing support and the housing is defined by subtracting a predetermined angle from the first angle.

Therefore, a stable state of assembly may be achieved by suppressing the non-uniform distribution of forces acting on the housing via a bearing support from the input and/or output shaft.

### BRIEF DESCRIPTION OF THE DRAWINGS

Referring now to the attached drawings which form a part of this original disclosure:

FIG. 1 is a schematic top plan view of an example of a power train of a four-wheel drive vehicle equipped with a drive force distributing apparatus according to a first disclosed embodiment;

FIG. 2 is a vertical cross-sectional side view of the drive force distributing apparatus shown in FIG. 1;

FIG. 3 is a vertical cross-sectional front view of a crankshaft used in the drive force distributing apparatus;

FIGS. 4A through 4C is a series of views illustrating operation diagrams of the drive force distributing apparatus shown in FIG. 2, with FIG. 4A illustrating an operation diagram in which the first roller and the second roller are separated from each other at crankshaft rotation angle at reference position of “0” degree, FIG. 4B illustrating an operation diagram in which the first roller and the second roller are in contact state at 90 degrees, and FIG. 4C illustrating the contact state between the first roller and the second roller at crankshaft angle being at 180 degrees;

FIG. 5 is a characteristic diagram illustrating a responsive time with respect to an oil temperature in a first embodiment;

FIG. 6 is a schematic view illustrating the rotational relationship among the second roller, the crankshaft and the roller bearing in the first embodiment;

FIG. 7 is a flowchart illustrating a selection process of the rotational direction in the drive force distributing mechanism in the first embodiment; and

FIG. 8 is a diagram illustrating the rotation position at the top dead center (T.D.C.) viewed along arrow A in FIG. 2.

### DETAILED DESCRIPTION OF THE PREFERRED EMBODIMENTS

Selected embodiments of the present invention will now be explained with reference to the drawings. It will be apparent to those skilled in the art from this disclosure that the following descriptions of the embodiments of the present invention are provided for illustration only and not for the purpose of limiting the invention as defined by the appended claims and their equivalents.

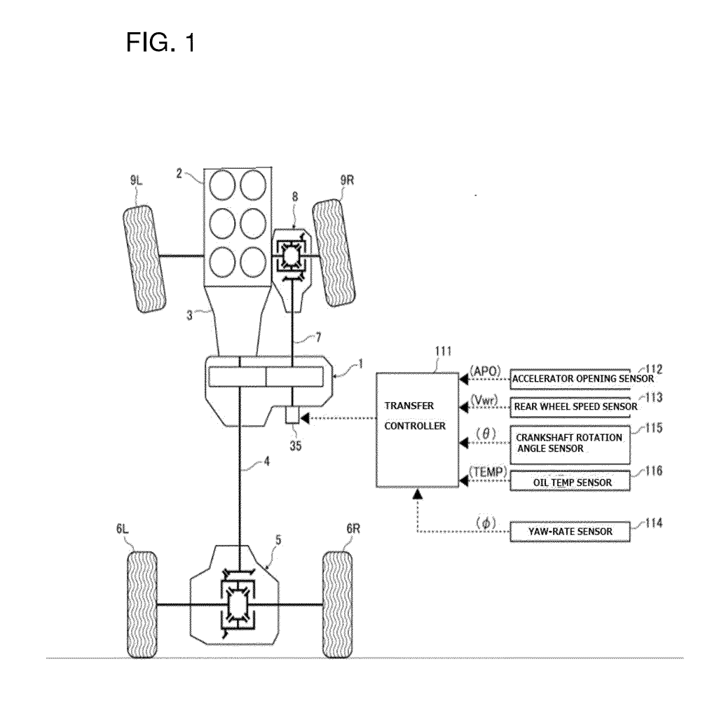

FIG. 1 is a schematic top plan view of a power train of a four-wheel drive vehicle equipped with a drive force distributing apparatus 1 according to a first disclosed embodiment. In this embodiment, the drive force distributing apparatus 1 can operate as a transfer case. Since the basic structure is the same as those disclosed in U.S. Patent Application Publication No. 2011/0319223 A, filed by the current Applicant, which is incorporated by reference into the present application.

The four-wheel drive vehicle is based on a rear wheel drive configuration in which torque from an engine 2 is multiplied by a transmission 3 and is transferred through a rear propeller shaft 4 and a rear final drive unit 5 to left and right rear wheels 6L and 6R. The vehicle can operate in a four-wheel drive manner by using the drive force distributing apparatus 1 to divert a portion of the torque being provided to the left and right rear wheels (main drive wheels) 6L and 6R through a front propeller shaft 7 and a front final drive unit 8 to transmit torque to left and right front wheels (subordinate drive wheels) 7L and 7R.

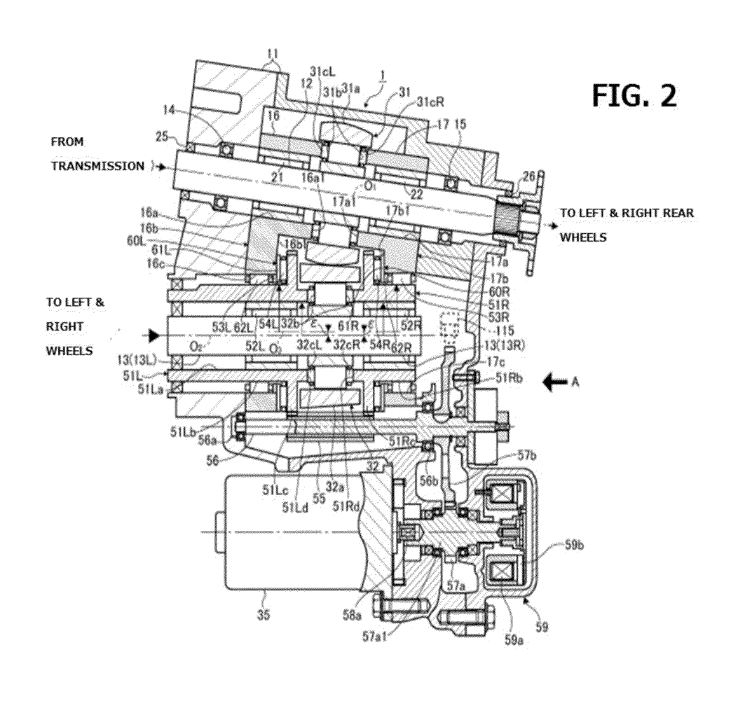

The drive force distributing apparatus 1 thus determines a drive force distribution ratio between the left and right rear wheels (main drive wheels) 6L and 6R and the left and right front wheels (subordinate drive wheels) 9L and 9R. In this embodiment, the drive force distributing apparatus 1 can be configured as shown in FIG. 2.

That is, as shown in FIG. 2, the apparatus includes a housing 11. An input shaft 12 and an output shaft 13 are arranged to span across an inside of the housing 11 diagonally with respect to each other such that a rotational axis O₁ of the input shaft 12 and a rotational axis O₂ of the output shaft 13 intersect each other. The input shaft 12 is rotatably supported in the housing 11 on ball bearings 14 and 15 located at both ends of the input shaft 12. Furthermore, both ends of the input shaft 12 protrude from the housing 11 and are sealed in a liquid-tight fashion or a substantially liquid-tight fashion by seal rings 25 and 26. In this arrangement, one end of the input shaft 12 shown at the left side of FIG. 2 is coupled to an output shaft of the transmission 3 (see FIG. 1). Also, the other end of the input shaft 2 at the right side of FIG. 2 is coupled to the rear final drive unit 5 through the rear propeller shaft 4 (see FIG. 1)

In addition, a pair of bearing supports 16 and 17 is provided between the input shaft 12 and the output shaft 13 in positions near the ends of the input shaft 12 and the output shaft 13. The bearing supports 16 and 17 are fastened to axially opposite internal walls of the housing 11 with fastening bolts (not shown), at approximate middle portions of the bearing supports 16 and 17. Bearing support 16, 17 is provided with an input shaft through bore 16a, 17a, output shaft through bore 16c, 17c for passing through the output shaft 13 and crankshaft 51L, 51R, and a vertical wall 16b, 17b connecting between the input shaft through bore 16a, 17a and output shaft through bore 16c, 17c, and is generally shaped glasses in the axial direction front view. Roller bearings 21, 22 are arranged between the bearing supports 16, 17 and input shaft 12 for supporting the input shaft 12 freely or rotatably relative to bearing supports 16, 17 so that input shaft 12 is supported inside the housing 11 rotatably through the bearing supports 16, 17 as well.

A first roller 31 is formed integrally and coaxially with the input shaft 12 in an axially intermediate position located between the bearing supports 16 and 17, that is, between the roller bearings 21 and 22. A second roller 32 is formed integrally and coaxially with the output shaft 13 in an axially intermediate position such that the second roller 32 can make frictional contact with the first roller 31. The first roller 31 and the second roller 32 are arranged in a drive force transmitting manner via working fluid or oil. Naturally, the first roller 31 can instead be attached to the input shaft 12 in any suitable manner instead of being integral with the input shaft 12. Likewise, the second roller 32 can instead be attached to the output shaft 13 in any suitable manner instead of being integral with the input shaft 12. The outer circumferential surfaces of the first roller 31 and the second roller 32 are conically tapered in accordance with the diagonal relationship of the input shaft 12 and the output shaft 13 such that the outer circumferential surfaces can contact each other without or substantially without a gap between the surfaces. At both sides of radial extension of the first roller 31 and the second roller 32 are formed with retention grooves 31b, 32b to contact with and retain radially thrust bearings 31cl, 31cR, 32cl. 32cR. The thrust bearings 31cL, 31cR positions first roller 31 by contacting the first side walls 16a1, 17a1 of bearing supports 16, 17. On the other hand, the thrust bearings 32cL, 32cR positions second roller 32 by contacting the roller side contact portions 51Ld, 51Rd of crankshaft 51L, 51R described below.

The output shaft 13 is turnably supported with respect to the bearings supports 16 and 17 at positions near both ends of the output shaft 13. Thus, the output shaft 13 is supported to be turned inside the housing 11 through the bearing supports 16 and 17. A support structure used to support the output shaft 13 in a turnable manner with respect to the bearing supports 16 and 17 is realized by an eccentric support structure as will now be explained.

As shown in FIG. 2, a crankshaft 51L configured as a hollow outer shaft is moveably fitted between the output shaft 13 and the bearing support 16. Also, a crankshaft 51 R configured as a hollow outer shaft is moveably fitted between the output shaft 13 and the bearing support 17. The crankshaft 51L and the output shaft 13 protrude from the housing 11 as shown on the left side of FIG. 2. At the protruding portion, a seal ring 27 is installed between the housing 11 and the crankshaft 51L. Also, a seal ring 28 is installed between the crankshaft 51L and the output shaft 13. The seal rings 27 and 28 serve to seal the portions where the crankshaft 51 L and the output shaft 13 protrude from the housing 11 in a liquid-tight or substantially liquid-tight fashion.

The left end of the output shaft 13 protruding from the housing 11 in FIG. 2 is coupled to the front wheels 9L and 9R through the front propeller shaft 7 (see FIG. 1) and the front final drive unit 8.

A roller bearing 52L is arranged between a center hole 51La (radius Ri) of the crankshaft 51 L and a corresponding end portion of the output shaft 13. Also, a roller bearing 52R is arranged between a center hole 51 Ra (radius Ri) of the crankshaft 5 1 R and a corresponding end portion of the output shaft 13. Thus, the output shaft 13 is supported such that the output shaft 13 can rotate freely about the center axis O₂ inside the center holes 5 1 La and 51Ra of the crankshaft 51L and 51R

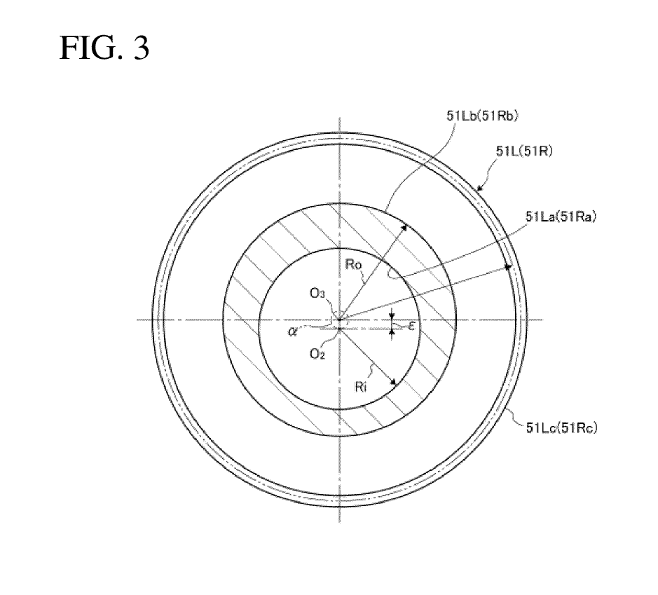

As shown clearly in FIG. 3, the crankshaft 51 L has an outer circumferential portion 51 Lb (center shaft axis O3, radius Ro) that is eccentric with respect to the center hole 51 La. Also, the crankshaft 51 R has an outer circumferential portion 51 Rb (center shaft axis O3, radius Ro) that is eccentric with respect to the center hole 51 Ra. The eccentric outer circumferential portions 51 Lb and 51 Rb are offset from the center axis (rotational axis) O₂ of the center holes 51 La and 51 Ra by an eccentric amount ε. The eccentric outer circumferential portion 51Lb of the crankshaft 51 L is rotatably supported inside the corresponding bearing support 16 through a roller bearing 53L. The eccentric outer circumferential portion 51Rb of the crankshaft 51 R is rotatably supported inside the corresponding bearing support 17 through a roller bearing 53R. In addition, the roller side contact portions 51Ld, 51Rd of crankshafts 51L, 51R are freely and rotatably supported on thrust bearings 32cL, 32cR. Further, thrust bearings 54L, 54R are provided axially outside with respect to thrust bearings 32cL, 32cR. These thrust bearings 54L, 54R contact spacers 60L, 60R rotatably and also contact ring gears 51Lc, 51Rc rotatably to thereby support crankshaft 51L and 51R rotatably fee.

Spacers 60L, 60 R are composed of a first spacer portions 61L, 61R which respectively contacts the second wall surface 16b1, 17b1 of the vertical wall 16b, 17b facing the second roller 32 and respectively extends radially inwardly of output shaft through bore or hole 16c, 17c up to a position of contact free of the crankshaft 51L and a second spacer portions 62L, 62R (extension portion) that respectively extends to be inserted in the output shaft bore 16c, 17c. In addition, spacers 60L, 60R are positioned radially through contact between the outer periphery of the second spacer portions 62L, 62R and the inner periphery surface of output shaft through bores 16c, 17c while mutual interference between roller bearings 53L, 53R and thrust bearing 54R, 54L are avoided.

Thus, since, by extending radially inwardly first spacer portions 61L, 61R, thrust bearing 54R, 54L are provided along the radial direction of the first spacer portions 61L, 61R, the capacity of the bearing may be increased without increase in size in the radially outward direction. Further, due to large-sized roller bearings 53L, 53R, even when the gap is increased between crankshaft 51L, 51R and inner periphery of output shaft hole or bore 16c, 17c of bearing supports 16, 17, thrust bearings 54L, 54R may be received at an radially inner side by the first spacer portions 61L, 61R so that the size increase in the radial direction may be avoided.

In addition, since the positioning in the radial direction is performed at the outer periphery of the second spacer portions 62L, 62R, contact between spacers 60L, 60R and crankshaft 51L, 51R may be avoided and friction loss due to increase in sliding resistance may be suppressed. Stated another way, while crankshaft 51L, 51R relatively rotate to bearing supports 16, 17, spacers 60L, 60R do not rotate relative to bearing supports 16, 17. Therefore, by positioning using rotation-fee members, points of contact may be reduced.

The ring gears 51 Lc and 51Rc are meshed with the crankshaft drive pinion 55 such that the eccentric outer circumferential portions 51Lb and 51Rb of the crankshafts 51 L and 51R are aligned with each other in a circumferential direction. That is, the rotational positions of the eccentric outer circumferential portions 51 Lb and 51 Rb are in phase with each other.

The pinion shaft 56 is rotatably supported with respect to the housing 11 by bearings 56a and 56b arranged at both ends of the pinion shaft 56. A right end of the pinion shaft 56 passes through the housing 11 as shown on the right-hand side of FIG. 2. An exposed end portion of the pinion shaft 56 is operably coupled to an output shaft 58a of an inter-roller radial pressing force control motor 35 through serration coupling and the like.

At the right end of pinion shaft 56, that is in the ride side in FIG. 2, a large diameter output gear 57b (first output gear) is fixed. At the side of outer diameter of the large diameter output gear 57b is provided a crankshaft rotation angle sensor 115 as shown by arrow A, which detects the protrusions and indents 57b1, 57b2 of teeth surfaces of the large diameter output gear 57b to detect the rotation angle of crankshaft 51L, 51R. The crankshaft rotation sensor 115 is a magnetic sensor to detect the protrusions and indents formed by the teeth of the large diameter output gear 57b and to detect the rotation angle of the pinion shaft 56 and that of crank shaft 51L, 51R. In the case of the rotation angle sensor of the type in which the teeth of the large diameter output gear 57b is detectable, as compared to the expensive arrangement such as a rotary encoder that requires components on both sides of the rotation body and the stator, rotation angle may be detected with much more compact space at low cost. In addition, consideration may be given advantageously to the arrangement in which the sensor can be mounted from the outer periphery side of housing 11 which provides a spacious area around periphery of the large diameter output gear 57b.

Further, at the outer periphery of the large diameter output gear 57b is provided in meshed relationship a small diameter output gear 57a (second output gear). The small diameter output gear 57a is integrally formed with the smaller diameter output gear shaft 57a1, and is mounted to the motor drive shaft 58a of motor 35 on the left end side in FIG. 2 for joint rotation with motor 35. These components including crankshafts 51L, 51R, pinion shaft 56, large diameter output gear 57b, small diameter output gear 57a, small diameter output shaft 57a1 and inter-roller pressing force control motor 35 are described as an adjustment mechanism collectively.

On the right end side of the small diameter output gear shaft 57a1 is provided with an electromagnetic brake 59 to selectively stop the rotation of the small diameter output gear shaft 57a1. The electromagnetic brake 59 includes a coil 59a for generating magnetic force and a clutch plate 59b that is splined at the right end of the small diameter output gear shaft 57a1 for allowing an axial stroke.

An armature is provided on the clutch plate 59b. The clutch plate 59b moves axially due to electromagnetic attraction force to be fixed to yoke at the outer periphery of coil 59b in response to energizing of the coil 59a. When the electromagnetic clutch 59 is ON (engaged state), pinion shaft 56 may be fixed despite the application of torque on the side of pinion shaft 56 such that a predetermined inter-roller center distance may be maintained. On the other hand, when the electromagnetic clutch is in OFF state (released or disengaged state), the rotational movement of motor 35 may be transmitted to pinion shaft 56 to achieve a predetermined inter-roller center distance.

Therefore, rotational position control can be executed with respect to the crankshafts 51L and 51R by driving the crankshafts 51 L and 51 R with the inter-roller radial pressing force control motor 58 through the pinions 55 and the ring gears 51 Lc and 51Rc. When this occurs, the output shaft 13 and the rotation axis O₂ of the second roller 32 turn about the center axis (rotational axis) O₃ so as to revolve along a circular path α indicated with a broken line in FIG. 3.

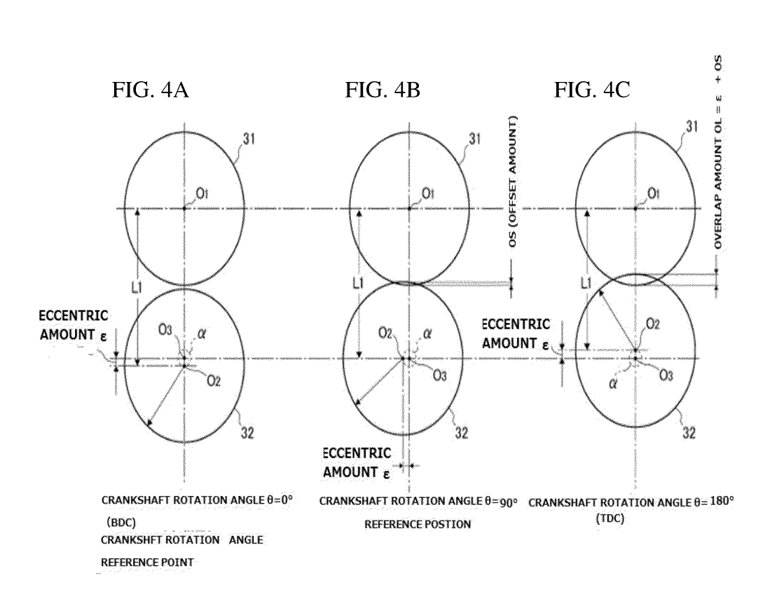

As will be described in detail later, by the turn or rotation of rotation shaft axis O2 (second roller 32) along a locus circle path a in FIG. 3, the second roller 32 approaches the first roller 31 as shown in FIGS. 4A to 4C in the radial direction. Thus, as the rotation angle θ of crankshafts 51L, 51R increases, the roller center distance L1 between the first roller 31 and the second roller 32 may be decreased less than the sum of the radius of the first roller 31 and the radius of the second roller 32 will cause the radial pressing force of the second roller 32 on the first roller 31 (inter-roller transmission torque capacity; traction transmission capacity) to be increased. Therefore, in response to the decrease in the inter-roller center distance L1, the inter-roller radial depressing force (inter-roller transmission torque capacity; traction transmission capacity) may be variably controlled to adjust the drive force distribution ratio freely.

Note that, as shown in FIG. 4A, in the present embodiment, the inter-roller center distance L1 in a state of bottom dead center (B.D.C.) in which the rotation shaft axis O2 is located directly below the rotation axis O3 of crankshaft and the inter-roller distance between first roller 31 and second roller 32 becomes maximum is configured to be larger than the sum of the radius of first roller 31 and the radius of the second roller 32. Thus, at the bottom dead center with crankshaft rotation angle being “0” degree, the first roller 31 and the second roller 32 are prevented from being pressed each other in a radial direction so that such a state may be provided in which no traction transmission between rollers 31, 32 takes place, i.e., traction transmission capacity being “0”. Therefore, traction capacity may be set arbitrarily to a value anywhere between “0” at the bottom dead center and the maximum value obtainable at the top dead center (T.D.C.) in FIG. 4C (i.e., θ=180 degrees). In the present embodiment, description is made by setting a rotation angle reference of crankshaft 51L, 51R at the bottom dead center, i.e., crankshaft rotation angle being “0”.

With reference to FIGS. 1 to 4, the operation of drive force distribution is now described. An output torque from the transmission 3 (shown in FIG. 1) is imparted input shaft 12 of transfer 1. The torque can be further transmitted directly from the input shaft 12 to the left and right rear wheels 6L and 6R (main drive wheels) through the rear propeller shaft 4 and the rear final drive unit 5 (both being shown in FIG. 1).

Also, when the inter-roller distance L1 (shown in FIG. 4) is set less than the sum of the radius of first roller 31 and the radius of second roller 32 in response to the rotation position control of crankshafts 51L, 51R by motor 35 through pinion 55 and ring gears 51Lc, 51Rc, the transfer 1 acquires an inter-roller transmission torque capacity in accordance with the radial pressing force between first roller 31 and second roller 32. Depending on this torque capacity, transfer 1 can divert a portion of the torque from the left and right rear wheels 6L and 6R (main drive wheels) toward the output shaft 13 by passing torque from the first roller 31 to the second roller 32. A torque reaching the output shaft 13 is transmitted to drive the left and right front wheels (subordinate drive wheels) 9L and 9R. Therefore, the vehicle can be operated in a four-wheel drive mode in which the left and right rear wheels 6L and 6R (main drive wheels) and the left and right front wheels (subordinate drive wheels) 9L and 9R are driven.

Note that, during torque transmission, a reaction force of the radial pressing force between first roller 31 and second roller 32 are received by bearing supports 16, 17 without reaching housing or case 11. Further, the reaction force of the radial pressing force remains “0” when the crankshaft rotation angle is within a range between 0 and 90 degree, increases in accordance with increase in crankshaft rotation angle θ between 90 and 180 degrees, and will assume the maximum value at the crankshaft rotation angle θ being 180 degrees.

During travel in the four-wheel drive mode, when the rotation angle θ of crankshaft 51L, 51R is set at a reference position of 90 degrees, the first roller 31 and second roller 32 are pressed against each other for frictional contact at a radial pressing force corresponding to an offset amount OS at this time, torque transmission takes place to left and right front wheels (subordinate drive wheels) 9L, 9R in accordance with the offset value OS between the two rollers.

As the rotation angle θ of crankshaft 51L, 51R increases from the reference position shown in FIG. 4B toward the top dead center with crankshaft rotation angle δ being at 180 degrees as shown in FIG. 4C, the inter-roller center distance L1 further decreases to increase the overlap amount OL between first roller 31 and second roller 32. Consequently, the radial pressing force between first roller 31 and second roller 32 will be increased to thereby increase the traction transmission capacity between these rollers.

When crankshafts 51L, 51R have reached the position of top dead center shown in FIG. 4C, first roller 31 and second roller 32 are pressed at the maximum radial pressing force corresponding to the maximum overlap amount OL so that the traction transmission capacity between the two will be made maximum. Note that the maximum overlap amount OL is obtained by adding the eccentric amount ε between the second roller rotation axis O2 and crankshaft rotation axis O3 to the offset amount OS described with reference to FIG. 4B.

As will be appreciated from the description above, by operating crankshafts 51L, 51R to rotate from the position of “0” crankshaft rotation angle to the position of “180” crankshaft rotation angle, an inter-roller traction transmission capacity may be varied continuously from “0” to maximum. Conversely, by operating crankshafts 51L, 51R to rotate from the position of “180” crankshaft rotation angle to the position of “0” crankshaft rotation angle, the inter-roller traction transmission capacity may be varied continuously from maximum to “0”. Thus, the inter-roller traction transmission capacity may be controlled freely or variably by the rotational operation of crankshafts 51L, 51R.

During a four-wheel drive travel described above, transfer 1 outputs and conveys a part of the torque t left and right rear wheels (main drive wheels) 6L, 6R to left and right front wheels (subordinate drive wheels) 9L, 9R. Thus, the traction transmission capacity between the first roller 31 and the second roller 32 is required to correspond to a target front wheel drive force to be distributed to left and right front wheels (subordinate wheels) that is obtainable based on the drive force to left and right rear wheels (main drive wheels) 6L, 6R and the distribution ratio of front to rear wheel target drive force

In the present embodiment, in order to perform a required traction transmission capacity control, a transfer controller 111 is provided shown in FIG. 1 to carry out control of the rotational position (control of rotation angle θ of crankshaft) of motor 35.

Therefore, transfer controller 111 receives a signal from accelerator pedal opening sensor 112 to detect the accelerator depressing amount (accelerator pedal opening degree) APO to adjust the output of engine 2, a signal from rear wheel speed sensor 113 to detect the rotational peripheral speed Vwr of left and right rear wheels 6L, 6R (main drive wheels), a signal of yaw-rate sensor 114 to detect a yaw-rate φ about the vertical axis passing through the center of gravity of the vehicle, a signal from the crankshaft rotation angle sensor 115 to detect the rotation angle θ of crankshaft 51L, 51R, and a signal of a oil temperature sensor 116 to detect a temperature TEMP of working oil within the transfer 1 (housing 11).

Based on the detection information of each sensor 112 to 116 described above, transfer controller 111 generally controls the traction transmission capacity (front to rear wheel drive force distribution control of four wheel drive vehicle) in the following manner.

Specifically, transfer controller 111 first obtains both the drive force of left and right wheels 6L, 6R (main drive wheels) and the front to rear target drive force distribution ratio in a known manner.

Subsequently, transfer controller 111 acquires a target front wheel drive force to be conveyed to left and right front wheels (subordinate wheels) 9L, 9R based on the drive force of left and right rear wheels 6L,6R (main drive wheels) and the target distribution ratio between front and rear drive force.

Further, transfer controller 111 obtains a required radial inter-roller pressing force (traction transmission capacity) imparted by first roller 31 and second roller 32 necessary to transmit the target front drive force, and then calculates a target rotation angle t θ of crankshaft 51L, 51R (see FIGS. 2, 3), that is, target rotation angle of second roller axis O2 necessary to achieve the radial inter-roller pressing force (traction transmission capacity between first roller 31 and second roller 32).

Then, transfer controller 111 controls to drive the inter-roller pressing force control motor 35 such that crankshaft rotation angle θ matches the target crankshaft rotation angle t θ in accordance with the difference between the crankshaft rotation angle θ detected by sensor 115 and the target crankshaft rotation angle t θ. When the rotation angle θ of crankshaft 51L, 51R matches the target value t θ, the first roller 31 and the second roller 32 are pressed to each other to be capable of transmuting the target front wheel drive force and the first roller 31 and second roller 32 may be controlled to allow the traction transmission capacity to match the target front to rear wheel drive force distribution.

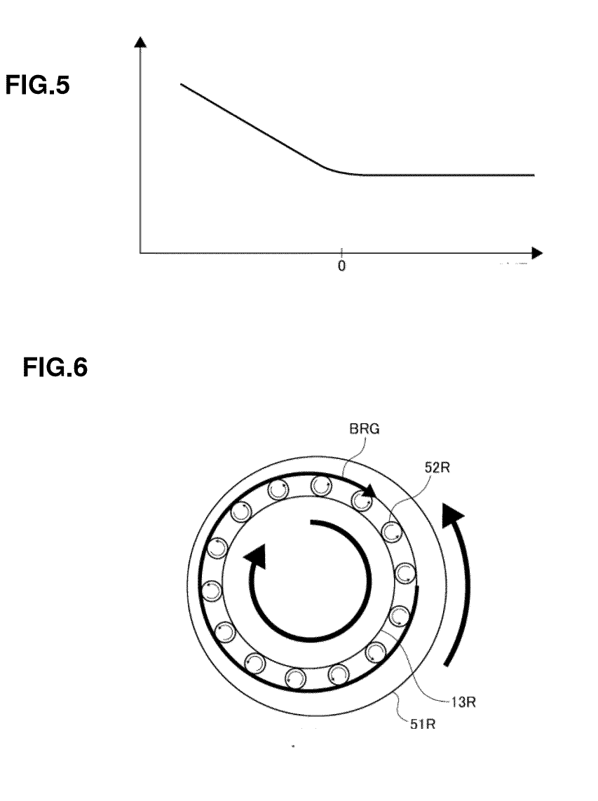

Description is now made in which direction the crankshafts 51L, 51R are to be rotated during driving control of the motor for controlling the inter-roller pressing force. FIG. 5 is a characteristic diagram illustrating the relationship between the response time for oil temperature in the drive force distributing apparatus in the first embodiment. The response time in this instance is defined for example to be the time required for the rotation angle θ of the crankshafts 51L, 51R to attain the target value t θ in response to a control command for a predetermined drive force distribution. In the region of 0° C. or above oil temperature, no particular change is appreciated in the response time, and the target is achieved by the response time of the certain magnitude. In contrast, in the region of the oil temperature below 0° C., it can be seen that the response time is slower as the oil temperature decreases. This is considered by the increase in viscosity of the oil due to reduction of oil temperature, so that the drag torque at sliding portions increases with increase in energy loss even at the control command of the same output.

Example, when outputting a control command to be a driving force distribution given, it is the time required rotation angle θ crankshafts 51L, the 51R to reach the target value tθ.

Here, in the drive force distributing apparatus in the first embodiment, the direction of rotation of the second roller 32 and the turning direction of the second roller 32 are essentially controlled to be opposite to each other (hereinafter referred to as a reverse direction control). As has been explained in conjunction with the above referenced document (i.e. JP 2010-169171 A), the rotation moment caused by the radial inter-roller pressing force and the rotation moment due to tangential force are the same direction, and the total of these rotation moments maintains the same polarity throughout the whole region of the crankshaft rotation angle θ. Thus, because the orientation of the total torque does not change, the drive force distribution control may be performed with high precision.

However, in such a reverse rotation control, the following problems arise. FIG. 6 shows a schematic diagram illustrating the relative rotational relationship among the second roller, crankshaft and the roller bearing in the first embodiment. As shown, when the end portion 13R of the output shaft 13 is rotating clockwise, the roller bearing 52R is rotated counter-clockwise, the crank shaft 51R will be rotated counterclockwise. At this time, the rotation direction of the second roller and the rotation direction of the crankshaft are reversed, the rotation direction of the drag torque acting between the crankshaft and the bearing and the rotation direction of the torque for drivingly rotating the crankshaft become in the opposite direction. Therefore, when the drag torque is increased at low oil temperature, ensuring the control response will be difficult due to reduction in rotational drive torque as total torque acting on the crankshaft.

Therefore, in a running state in which drag torque will be increased with the response time increase (specifically in a state with oil temperature at or less than a predetermined temperature lower than 0°), the direction of rotation of the crankshaft 51 will be intended to be controlled in the opposite direction, i.e. in clockwise direction in FIG. 6. By controlling the rotation direction of the second roller 32 and the turning direction of the in the same direction (hereinafter referred to identical rotation control that maintains this relationship), the direction of drag torque and the rotation direction of crankshaft 51 are in the same direction so that the response time will be improved.

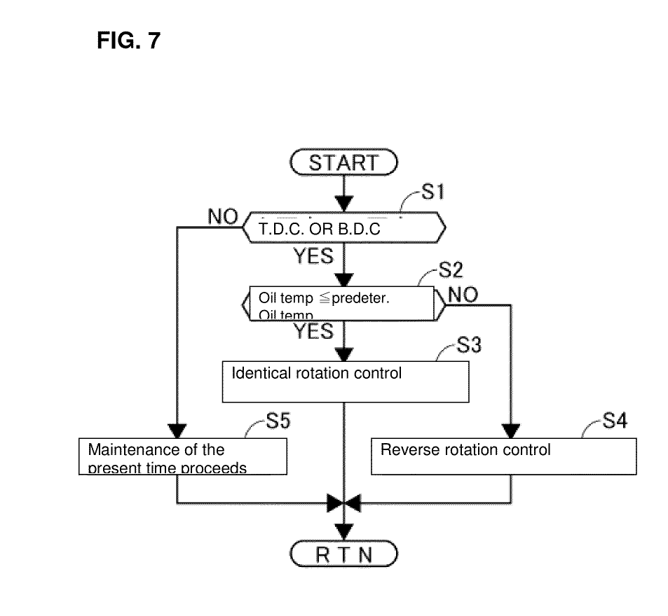

FIG. 7 is a flowchart showing the direction control selection process in the drive force distribution control in the first embodiment. In step S1, it is determined whether the rotation angle θ crankshafts 51L, the 51R is at the top dead center of is 180° or at the bottom dead point of 0°, and if either of these is confirmed, the process proceeds to step S2, while otherwise the process proceeds to step S5 where the rotation control currently in progress will be maintained. In step S2, it is determined whether or not oil temperature is a predetermined oil temperature or less, that represents increase in drag force, and when determined below the predetermined oil temperature, the process proceeds to step S3, while otherwise process proceeds to step S4. In step S3, the identical rotation control is adopted at the determination that drag torque is on increase and accordingly controls the crankshaft rotation control of which is adopted at the present time proceeds to step S5 when the rotation angle θ. In step S4, the reverse rotation control will be adopted at the determination of no increase in drag torque such that the crankshaft rotation angle θ is controlled under the reverse rotation control.

First, during the drive control, it is assumed that, in the midst of control in which either the identical rotation control or the reverse rotation control is selected and being in place, control is switched over form the control being selected to the other control (i.e., when the oil temperature detected during the drive force distribution crosses a predetermined oil temperature). At this time, in order to move to the position of “−θ” from the position of the rotation angle θ, the process has to go through the bottom dead center or top dead center. Therefore, when going through the top dead center, the drive force distribution becomes excessive, while going through the bottom dead center, the drive force distribution becomes 0, which may cause the driver to feel uncomfortable. Therefore, first, when the rotation angle θ is present in a state of the selected rotation control at this time, the current state is maintained to avoid the discomfort due to fluctuations in the drive force.

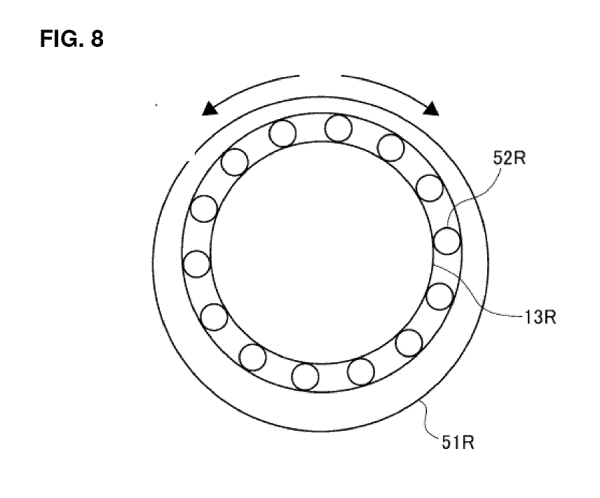

On the other hand, when the rotation angle is either at the bottom dead center or top dead center, any discomfort would not occur even at switching of the rotation control. Specifically, in a state of bottom dead center, since the first roller 31 and the second roller 32 are spaced from each other, no effect will be affected on the drive force distribution. Now, explanation is made of the state of the top dead center. FIG. 8 is a view showing a rotation position in the top dead center viewed from arrow A in FIG. 2. In the state of top dead center, even at an attempt to rotate clockwise from this state, no further distribution of drive force is expected such that the rotation in any direction would not cause change in the drive force distribution.

To sum up, the process allows switching of the rotation control only at states either at top dead center or the bottom dead center, and otherwise the process continues the control currently being selected at the moment. Further, when the crankshaft rotation angle θ is located either at the top dead center or the bottom dead center, and when oil temperature is a predetermined oil temperature or less, the process switches over to the identical rotation control to avoid deterioration in response time due to drag torque. On the other hand, when oil temperature exceeds the predetermined oil temperature, control switches to the reverse rotation control in which no change in polarity of the rotation moment or torque will be expected, since the deterioration in response time would not occur. Thus, when the effect of the drag torque at the low temperature is concerned, the acting direction of the drag torque and the direction of rotation of the crankshaft 51 are matched to adopt an identical rotation control so that the control response will be prevented from being deteriorated.

(1) As described above, the following operational effects can be obtained in the present embodiment:

A drive force distributing apparatus including a first roller 31 rotatable jointly with left and right rear wheels 6L, 6R as main drive wheel system and a second roller 32 rotatable jointly with left and right front wheels 7L, 7R as subordinate drive wheel system in which a drive force distribution to left and right front wheels 7L, 7R (subordinate drive wheel system) is enabled by frictionally contacting the first roller and the second roller between the respective outer peripheral surfaces, wherein a shaft portion of the second roller 32 is rotatably supported via roller bearings 52R, 52L (bearing) in an eccentric bore of crankshaft 51L, 51R that in turn is rotatable about a fixed shaft axis O2 of a housing 11 and control of the drive force distribution between the left and right rear wheels (main drive system) and left and right front wheels (subordinate drive system) is carried out by turning the second roller 32 by the rotation of the crankshaft 51L, 51R about the fixed shaft axis O2 to thereby adjust a radial pressing force of the second roller 32 against the first roller 31 by an adjustment mechanism, comprising:

an oil temperature sensor 116 (oil temperature detection unit) to detect an oil temperature within the drive force distributing apparatus, wherein the adjustment mechanism performs a reverse rotation control in which the turning direction of the second roller 32 and the rotation direction of the second roller 32 are in the opposite direction when the detected oil temperature exceeds a predetermined temperature, while

the adjustment mechanism performs an identical rotation control in which the turning direction of the second roller 32 and the rotation direction of the second roller 32 is the same direction when the detected oil temperature is at the predetermined temperature or less.

Therefore, when the effect of drag torque during low temperature operation of the apparatus is concerned, by selecting the identical rotation control in which the acting direction of the drag torque and the rotation direction of crankshaft 51 are matched identical, the control response will be improved.

(2) The adjustment mechanism, when the detected oil temperature crosses the predetermined oil temperature during the drive force control under the rotation control of either the reverse rotation control or identical rotation control, switches over to the other rotation control when the crankshaft has reached the bottom dead center (i.e., when the radial pressing force of the second roller 32 falls below a predetermined value; see steps S1, S2).

Therefore, fluctuations in drive force distribution accompanied by switching operation of the rotation control may be prevented and the discomfort to the driver may be avoided.

(3) The adjustment mechanism is adopted, during the state of the top dead center at the radial pressing force of the second roller 32 being the maximum, to perform the drive force distribution from the one rotation control to the other when the detected oil temperature crosses the predetermined oil temperature.

Stated another way, because of no risk of further increase in drive force distribution increase at the top dead center in response to rotation in either direction, the rotation control will be switched promptly so that the drive force distribution control of high precision can be achieved.

In understanding the scope of the present invention, the term “comprising” and its derivatives, as used herein, are intended to be open ended terms that specify the presence of the stated features, elements, components, groups, integers, and/or steps, but do not exclude the presence of other unstated features, elements, components, groups, integers and/or steps. The foregoing also applies to words having similar meanings such as the terms, “including”, “having” and their derivatives. Also, the terms “part,” “section,” “portion,” “member” or “element” when used in the singular can have the dual meaning of a single part or a plurality of parts. Also as used herein to describe the above embodiments, the following directional terms “forward, rearward, above, downward, vertical, horizontal, below and transverse” as well as any other similar directional terms refer to those directions of a device equipped with the present invention. Accordingly, these terms, as utilized to describe the present invention should be interpreted relative to a device equipped with the present invention. The term “detect” as used herein to describe an operation or function carried out by a component, a section, a device or the like includes a component, a section, a device or the like that does not require physical detection, but rather includes determining, measuring, modeling, predicting or computing or the like to carry out the operation or function. The term “configured” as used herein to describe a component, section or part of a device includes hardware and/or software that is constructed and/or programmed to carry out the desired function. Moreover, terms of degree such as “substantially”, “about” and “approximately” as used herein mean an amount of deviation of the modified term such that the end result is not significantly changed.

While only selected embodiments have been chosen to illustrate the present invention, it will be apparent to those skilled in the art from this disclosure that various changes and modifications can be made herein without departing from the scope of the invention as defined in the appended claims. For example, the size, shape, location or orientation of the various components can be changed as needed and/or desired. Components that are shown directly connected or contacting each other can have intermediate structures disposed between them. The functions of one element can be performed by two, and vice versa. The structures and functions of one embodiment can be adopted in another embodiment. It is not necessary for all advantages to be present in a particular embodiment at the same time. Every feature which is unique from the prior art, alone or in combination with other features, also should be considered a separate description of further inventions by the applicant, including the structural and/or functional concepts embodied by such feature(s). Thus, the foregoing descriptions of the embodiments according to the present invention are provided for illustration only, and not for the purpose of limiting the invention as defined by the appended claims and their equivalents.

What is claimed is:

1. A drive force distributing apparatus including a first roller rotatable jointly with main drive wheels and a second roller rotatable jointly with subordinate drive wheels in which a drive force distribution to the subordinate drive wheels is enabled by frictionally contacting the first roller and the second roller between respective outer peripheral surfaces, wherein a shaft portion of the second roller is rotatably supported via a bearing in an eccentric bore of a crankshaft that in turn is rotatable about a fixed shaft axis of a housing, comprising:
an oil temperature detection unit configured to detect an oil temperature within the drive force distributing apparatus; and
an adjustment mechanism configured to:
control the drive force distribution between the main drive wheels and the subordinate drive wheels by turning the second roller by a rotation of the crankshaft about the fixed shaft axis to thereby adjust a radial pressing force of the second roller against the first roller;
perform a reverse rotation control in which the turning direction of the second roller and the rotation direction of the second roller are in opposite directions when the detected oil temperature exceeds a predetermined temperature; and
perform an identical rotation control in which the turning direction of the second roller and the rotation direction of the second roller is a same direction when the detected oil temperature is at the predetermined temperature or less.

2. The drive force distributing apparatus as claimed in claim 1, wherein the adjustment mechanism is further configured to:
switch over to the other rotation control when the crankshaft has reached the bottom dead center when the detected oil temperature crosses the predetermined oil temperature during the drive force control under the rotation control of either the reverse rotation control or identical rotation control.

3. The drive force distributing apparatus as claimed in claim 2, wherein the adjustment mechanism is further configured to:
perform the drive force distribution from the one rotation control to the other when the detected oil temperature crosses the predetermined oil temperature when a top dead center at the radial pressing force of the second roller is a maximum.
